(19) United States
(12) Patent Application Publication
(10) Pub. No.: US 2026/0065032 A1
(43) Pub. Date: Mar. 5, 2026

(54) INCORPORATING ALIGNMENT INTO SEQUENCE GENERATION NEURAL NETWORKS

(71) Applicant: DeepMind Technologies Limited, London (GB)

(72) Inventors: Martin Sundermeyer, Zurich (CH); Damien Vincent, Zurich (CH); Marco Tagliasacchi, Ruvigliana (CH); Zalán Borsos, Zurich (CH); Félix de Chaumont Quitry, Zurich (CH); Matthew Sharifi, Kilchberg (CH)

(21) Appl. No.: 18/824,046

(22) Filed: Sep. 4, 2024

(51) Int. Cl. G06N 3/0475; G06F 40/284; G06F 40/30; G06N 3/09; G06V 10/82; G10L 13/08

(52) U.S. Cl. CPC G06N 3/0475; G06N 3/09; G06F 40/284; G06F 40/30; G06V 10/82; G10L 13/08

(57) ABSTRACT

Methods, systems, and apparatus, including computer programs encoded on a computer storage medium, for generating an output with a corresponding alignment that defines how the output relates to the model input. In one aspect, a system comprises receiving a model input, processing the model input to generate an input sequence of input tokens that represent the model input, generating, by processing the input sequence of input tokens using a sequence generation neural network, a combined output sequence of tokens comprising alignment tokens and output tokens, wherein each alignment token encodes an alignment between at least one of the input tokens and one or more of the output tokens according to an alignment mapping encoding, and generating an output comprising one or more output elements by decoding at least the output tokens.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

This specification also relates to alignment. Within the context of machine learning, alignment refers to the relationship between the content of an input and the content of an output of a machine learning model. Alignment is especially important in natural language processing (NLP) tasks, where a high level of alignment between the content of the textual input and the generated output, e.g., text, image, video, audio, is necessary.

### SUMMARY

This specification describes a system implemented as computer programs on one or more computers in one or more locations that can process a model input to generate an output that explicitly accounts for the alignment between the model input and the model output.

In this specification, alignment refers to the relationship between the content of an input and the content of an output of a machine learning model. More specifically, alignment refers to a mapping defining how each input token in an input sequence of tokens, e.g., generated from the input, corresponds to an output sequence of tokens generated by the machine learning model, thereby encoding a relationship between the content of the input and the output. In particular, the system can be used to generate media, e.g., text, image, audio, video data, etc., as output from an input with a corresponding alignment mapping that defines how the output elements from the output relate to the model input.

As an example, the system can be used for text-to-speech or speech-to-text tasks to align input text with corresponding audio or spoken words with transcribed text. As another example, the system can be used for image captioning or video-question answering to ensure semantic consistency of generated captions or answers with input images or videos. As yet another example, the system can be used to align identified actions, objects, or both specified in a prompt with the actions, objects, or both in the generated image or video frame.

In particular, the system can process the model input to generate a corresponding input sequence of tokens and can use a sequence generation neural network to generate an output sequence of tokens from the input tokens that includes corresponding alignment tokens. The corresponding alignment tokens can explicitly encode an alignment mapping between the model input and the output elements of the output. More specifically, the token generation neural network can have been trained, e.g., using ground truth alignment tokens, to generate the combined output sequence of tokens that includes the corresponding alignment tokens at inference time.

The system can decode the combined output sequence of tokens to generate an output, e.g., including one or more output elements as represented by the combined output sequence of tokens. As an example, the system can decode the output tokens and the corresponding alignment tokens to provide explicit information regarding the alignment between the input and output elements, e.g., to a user. In some cases, the system can discard the decoded alignment tokens in a post-processing step. As another example, in the case that the output sequence of tokens and corresponding alignment tokens are not interdependent, the system can decode only the output tokens that pertain to the one or more output elements, e.g., not the corresponding alignment tokens, to generate the output elements.

According to a first aspect there is provided a method for receiving a model input, processing the model input to generate an input sequence of input tokens that represent the model input, generating, by processing the input sequence of input tokens using a sequence generation neural network, a combined output sequence of tokens comprising alignment tokens and output tokens, wherein each alignment token encodes an alignment between at least one of the input tokens and one or more of the output tokens according to an alignment mapping encoding, and generating an output comprising one or more output elements by decoding at least the output tokens.

Particular embodiments of the subject matter described in this specification can be implemented so as to realize one or more of the following advantages.

The techniques of this specification can be used to generate explicit alignment information using a sequence generation neural network. In particular, the system can generate a combined output sequence of tokens that includes both alignment tokens and output tokens pertaining to the content of the output, e.g., the output elements. The alignment tokens explicitly represent the relationship between the input tokens and the output tokens and can enhance the quality of the output.

More specifically, by generating alignment tokens and penalizing a discrepancy between the alignment tokens and ground truth alignment tokens during training, the system can provide explicit guidance to the neural network regarding the relationship between the input and a ground truth output resulting in generated high-quality outputs with desired characteristics during inference time. For example, generating alignment tokens as part of a combined sequence of output tokens can increase the likeness of the generated audio for text-to-speech to actual human-read audio, e.g., based on the prosody and ability of the system to account for repeated words, e.g., instead of exhibiting a failure pattern of leaving out repeated words, and the semantic quality of generated images with respect to a prompt specifying the intended contents of the image, relative to a system that does not generate alignment tokens. Additionally, the generated alignment tokens can optionally be provided as part of the output, e.g., to provide for a highlighting of spoken words in a text-to-speech system or for the rendering of bounding boxes around objects of interest in a generated image.

In addition, generating the alignment information at inference time can allow the system to bypass the use of other post-processing models, thereby reducing the use of computational resources, e.g., since there is no need to maintain or process the generated output and the input with an additional model to generate the explicit alignment. For example, in the case of a text-to-speech task, the system does not require the additional processing of the input and the generated output from the sequence generation neural network using a forced alignment model to generate the explicit alignment, e.g., for highlighting the text on a display as the generated output audio is played on a user device. As another example, in the case of an image generation task from a prompt specifying the contents of the image, the system can provide the bounding boxes around objects, actions, etc. without the need to process the generated output and the input using an object detection neural network, e.g., thereby enhancing the accountability and transparency of the model output based on the input to an end user.

The system can generate the output tokens according to any alignment mapping encoding, e.g., to provide more nuanced and finer-grained alignment information using arbitrary or multiple alignment mapping encoding functions. In some cases, the alignment between the input and output tokens is complex, e.g., a relationship that cannot be represented by a one-to-one mapping function. In these cases, the system vastly outperforms the use of explicit, but monotonic alignment mechanisms, e.g., a monotonic attention mechanism achieved by training a neural network using a monotonicity loss function. In particular, by allowing the flexibility to use one or more alignment mapping encoding functions, the system can explicitly account for more nuanced alignment information between the input sequence and the output sequence of tokens.

Additionally, in the case that the sequence generation neural network is a transformer, e.g., a large language model, the system can enhance the soft alignment inherent to the model architecture by generating the explicit alignment. In particular, large language models are configured to learn a soft alignment between the input sequence and output sequence of tokens, e.g., an implicit mapping that may or may not reflect the accurate alignment between input and output elements. As an example, a large language model trained without the incorporation of explicit alignment can generate a full stream of audio tokens from a given input text, but cannot predict where each word from the transcript starts or ends in the audio output, e.g., indicating that the large language model is not aligning the input and output elements consistently. In contrast, by generating alignment tokens as part of the combined sequence of output tokens, the sequence generation neural network is forced to explicitly account for the relationship between the input and output sequence of tokens.

Furthermore, the techniques of this specification can be used to explicitly incorporate alignment information in the training process for a neural network, e.g., to train the neural network to generate explicit alignment information at inference time. In particular, the system can train the neural network to generate alignment tokens according to an alignment mapping function with minimal changes to the network architecture, e.g., without the need for employing a separate output head that has to be trained to generate the alignment tokens. This decreases the resources necessary to train the neural network, e.g., since the model can accommodate the prediction of the alignment tokens with minimal changes to the architecture, and the computational overhead is minimal since there is no need to store, retrieve, or update a large number of additional neural network parameters in computational memory. More specifically, incorporating the alignment information during training can improve the quality of the generated output by providing guidance to the neural network regarding the explicit relationship between the input and output.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example alignment token generation system.

FIGS. 2A and 2B depict example alignment mapping encodings within the context of generating an audio transcript.

FIG. 3 illustrates an example of processing a textual input to generate an image with associated bounding boxes.

FIG. 4 demonstrates example results of a generated audio transcription using the example alignment token generation system of FIG. 1.

FIG. 5 is a flow chart of an example process for generating a combined output sequence of tokens using a sequence generation neural network that explicitly accounts for alignment.

FIG. 6 is a flow chart of an example process for training a sequence generation neural network to generate one or more alignment tokens as part of a combined sequence of output tokens.

Like reference numbers and designations in the various drawings indicate like elements.

### DETAILED DESCRIPTION

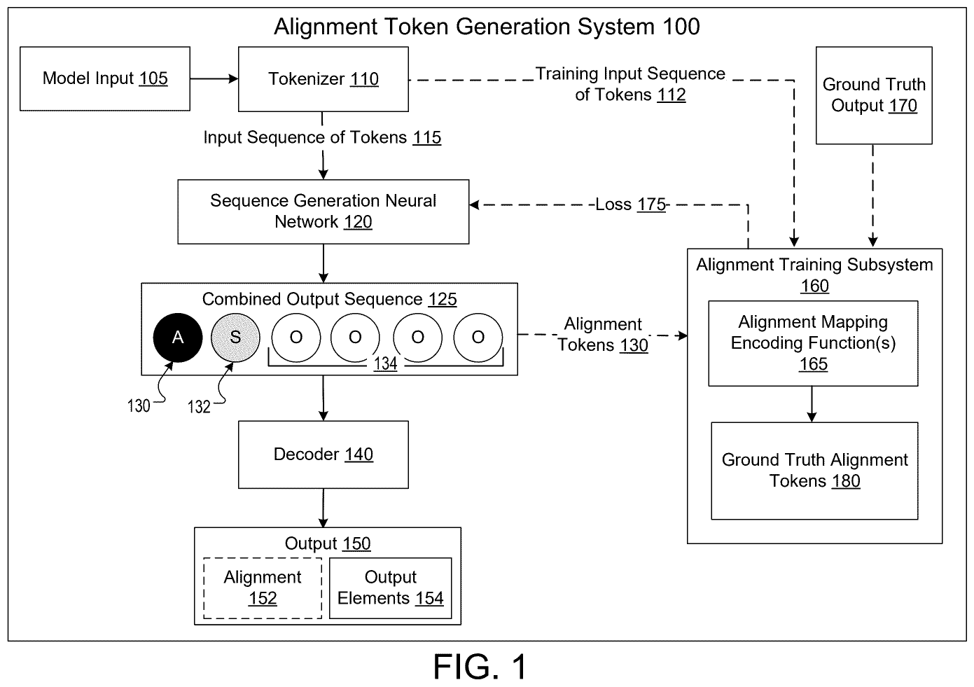

FIG. 1 shows an example alignment token generation system 100. The alignment token generation system 100 is an example of a system implemented as computer programs on one or more computers in one or more locations in which the systems, components, and techniques described below are implemented.

In particular, the alignment token generation system 100 can include a sequence generation neural network 120 that can be used to process an input 105 to generate media, e.g., media including text, image, audio, video, etc., as output 150 with an explicit corresponding alignment mapping that defines how the one or more output elements 154 of the output 150 relate to the model input 105. More specifically, rather than relying on an implicit soft-alignment between the input and generated output tokens that can be learned during the training process of the sequence generation neural network 120, the system 100 can explicitly incorporate alignment information into the generated combined output sequence 125 of the sequence generation neural network 120 to ensure an accurate alignment between the input 105 and the generated output 150.

The model input 105 can generally be any modality, e.g., a text, image, audio, or video modality, or multiple modalities. In particular, the type of model input 105 can depend on task(s) that the sequence generation neural network 120 is configured to perform, e.g., audio in a text-to-speech task, text in a speech-to-text task, an image or video in an object detection task, etc.

In some cases, the model input 105 can include a prompt, e.g., a directive instruction from a user, e.g., a question, statement, code snippet, or example. For example, the model input 105 can include a prompt specifying a question in a video-question answering task, an object to detect in an image or video, or a request to generate an image that includes a list of items or relationships.

The system 100 can process the model input 105 with a tokenizer 110 to generate a corresponding input sequence of tokens 115. More specifically, the tokenizer 110 can process the model input 105 to identify one or more subunits of the model input 105 as tokens. In some cases, the input sequence of tokens 115 is an input sequence of token embeddings that represents the model input 105, e.g., where each embedding relates a meaningful feature representation that includes the content and context from the model input 105. In particular, the system 100 can tokenize the model input 105 and can embed the resulting tokens as token embeddings, can directly encode the model input 105 as token embeddings, or both, as will be described in more detail below.

As an example, the tokenizer 110 can process a model input 105 that includes text to identify one or more phrases, words, or subwords as tokens. As another example, the tokenizer 110 can process a model input 105 that includes audio to identify one or more phonemes as tokens. As yet another example, the tokenizer 110 can process a model input 105 that includes an image to identify one or more image patches, e.g., patches from different regions of the image, as tokens.

In some cases, the tokenizer 110 can be a rules-based model, e.g., the tokenizer can identify the subunits of the model input 105 as tokens based on a set of rules. For example, the rules can define patterns to identify distinct tokens in the model input 105, e.g., using whitespace, punctuation, or words as token boundaries for a model input 105 that includes text, by using regions in an image to generate image patches as tokens, etc. In this case, the system 100 can embed the input sequence of tokens using an embedding layer of the sequence generation neural network 120, e.g., to generate an input sequence of token embeddings that can be used to generate the combined output sequence of tokens 125.

In other cases, the tokenizer 110 can be an embedding model with any appropriate architecture that can be configured to process the input 105 to generate an input sequence of token embeddings as the input sequence of tokens 115. In this case, each token embedding represents the content and context of the input 105 in a latent embedding space, e.g., a multi-dimensional space of a different size or shape than the size or shape of the model input 105. For example, the embedding model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

The system can process the input sequence of tokens 115 using the sequence generation neural network 120. The sequence generation neural network 120 can be a neural network with any appropriate machine learning architecture that can be configured to process the input sequence of tokens 115 to generate a combined output sequence of tokens 125. In particular, the sequence generation neural network 120 can process the input sequence of tokens 115 to generate the combined output sequence 125, e.g., a combined output sequence of token embeddings, that includes alignment tokens 130, semantic tokens 132, and output tokens 134 that pertain to the contents of the output 150.

For example, the sequence generation neural network 120 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers). In the case that the input sequence of tokens 115 was generated by a rules-based tokenizer, the sequence generation neural network 120 can first embed the input sequence of tokens 115, e.g., using an embedding layer. In the case that the input sequence of tokens 115 is a sequence of token embeddings, e.g., that was generated using an embedding model, the sequence generation neural network 120 can process the input sequence of tokens 115 directly, e.g., without embedding.

More specifically, the sequence generation neural network 120 can autoregressively generate each particular token in the combined output sequence of tokens 125 by conditioning on the current output sequence that includes tokens preceding the particular token being generated in the output sequence, e.g., including the alignment tokens 130. As an example, the sequence generation neural network 120 can have a recurrent neural network architecture that is configured to sequentially process the input sequence of tokens 115 and trained to perform next element prediction, e.g., to define a likelihood score distribution over a set of next elements. More specifically, the sequence generation neural network 120 can be a recurrent neural network (RNN), long short-term memory (LSTM), or gated-recurrent unit (GRU).

As another example, the neural network can be an auto-regressive Transformer-based neural network that includes (i) a plurality of attention blocks that each apply a self-attention operation and (ii) an output subnetwork that processes an output of the last attention block to generate the score distribution over next elements.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

As another example, the sequence generation neural network 120 can be a vision language model (VLM) that can be configured to process a model input 105 including a query and an image or sequence of images in a video to generate an intermediate representation of the image and perform an image processing task. For example, the sequence generation neural network 120 can be a contrastive language-image pre-training (CLIP) model, a vision transformer (ViT), a unified image-to-image translation (UNIT) model, or an attention generative adversarial network (AttnGAN).

As another example, the sequence generation neural network 120 can be a hybrid network that can perform object detection in a processed image, e.g., by predicting bounding boxes. For example, the sequence generation neural network 120 can be an attention-guided CNN, hybrid CNN-Transformer model, e.g., Detection Transformer (DETR), or feature pyramid networks.

As yet another example, the sequence generation neural network 120 can be a diffusion neural network. In this case, the sequence generation neural network 120 can sequentially refine an initial state including the input sequence of tokens 115 through a sequence of transformations, e.g., into the combined output sequence of tokens 125. For example, the sequence generation neural network 120 can be implemented as a denoising diffusion probabilistic model.

In particular, the alignment tokens 130 can specify the alignment between one or more of the input tokens and the output tokens, e.g., according to one or more alignment mapping encoding function(s) 165. More specifically, the combined output sequence of tokens 125 can include alignment tokens that explicitly encode an alignment between at least one of the input tokens and a subsequent sequence of one or more output tokens. For example, the alignment tokens 130 can represent an explicit mapping between the input sequence of tokens 115 and the output tokens that pertain to the content of the output, e.g., the semantic 132 and output tokens 134. In this case, the output tokens 134 can represent the contents of an output element, e.g., an entity from the sequence generation neural network's vocabulary, a spatial feature, etc., and the semantic tokens 132 can represent the semantic context of the output tokens 134.

For example, the sequence generation neural network 120 can generate one alignment token 130 for every output token 134. As another example, the sequence generation neural network 120 can generate multiple alignment tokens 130 for every output token 134. In some cases, the alignment tokens 130 are interleaved with the semantic and output tokens 132 and 134, e.g., the combined output sequence of tokens 125 includes an alternating sequence of alignment tokens 130 and output tokens 132, 134 that represent the semantic context and the contents of an output element, respectively.

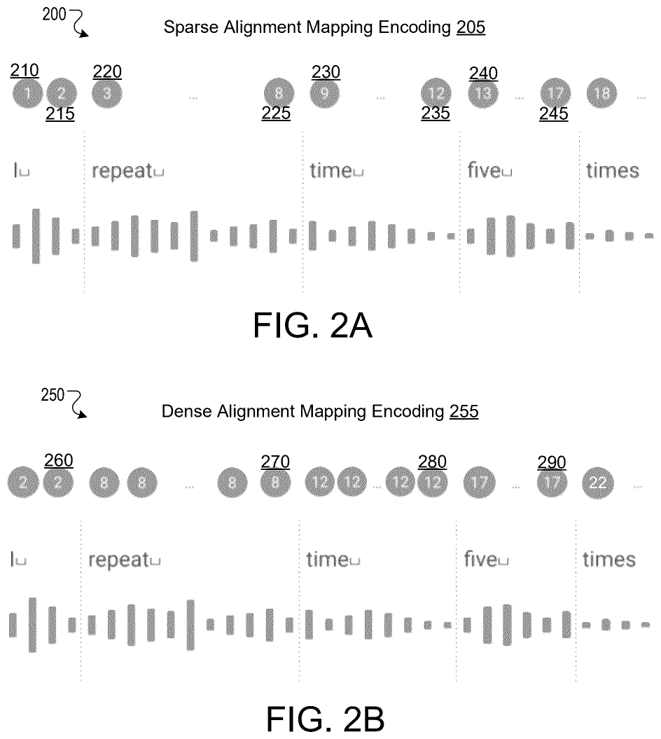

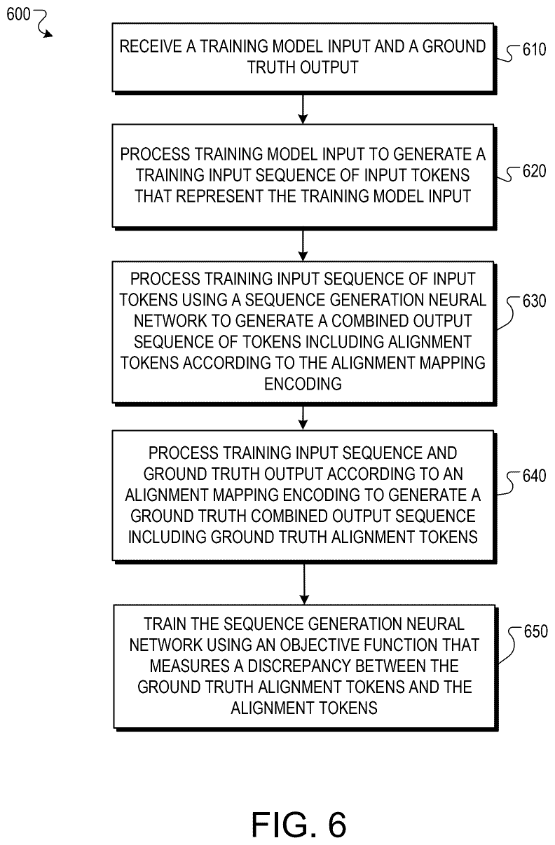

The alignment tokens 130 can include token embeddings generated according to an alignment mapping encoding. In particular, the alignment tokens 130 represent one or more particular mappings between the input sequence of tokens 115 and the output tokens 132, 134 according to one or more alignment mapping encoding function(s) 165 that is (are) defined to represent the relationship between the input 115 and output 132, 134 tokens. An example of two different alignment mapping encodings will be described in more detail with respect to FIG. 2. In particular, the system 100 can train the sequence generation neural network 120 using inputs in accordance with defined alignment mapping encoding function(s) 165, as will be described in more detail below and in FIG. 6.

As an example, the alignment token generation system 100 can employ time alignment tokens for text-to-speech or speech-to-text tasks. In particular, the sequence generation neural network 120 can process an input transcript including a number of semantic segments to generate a spoken variant of the semantic segments. In this case, the alignment tokens 130 can be time alignment tokens, e.g., for each time frame in the audio output, the system 100 can generate a combined output sequence of tokens 125, e.g., an interleaved sequence of time alignment tokens and output tokens.

In particular, the system 100 can process the input transcript using the sequence generation neural network 120 to generate continuous audio signal data at an audio resolution defined by a number of time frames, e.g., over a fixed number of milliseconds, tenths of seconds, seconds, etc., based on the processing of the input transcript to generate a corresponding combined output sequence 125 for the corresponding audio. For example, the sequence generation neural network 120 can be implemented as an AudioLM-2 architecture configured to process text to generate a corresponding spoken audio signal, e.g., as described in WIPO PCT Publication No. WO 2024/054556 A2, which is herein incorporated by reference.

In this case, the system 100 can generate time alignment tokens, e.g., the system 100 can generate the combined output sequence 125 that includes the time alignment token as the alignment token 130, the semantic token 132, and output tokens 134 at every time frame. As an example, the audio resolution can be fixed such that the sequence generation neural network 120 generates frames of audio features, e.g., a sequence of twelve tokens that represents the output audio signal based on the SoundStream residual vector quantization (RVQ) codec, as described in WIPO PCT Publication No. WO 2024/054556 A2.

As another example, the alignment token generation system 100 can be applied to image or video processing tasks, e.g., when there is a direct correspondence between pixels, or image patches, and model output labels. More specifically, the sequence generation neural network 120 can predict bounding boxes around objects of interest in an image, or allow for specific parts of an input prompt to be highlighted in a generated image, e.g., in the case of using a VLM, using the alignment tokens 130.

In the particular example depicted, the system 100 can decode the combined output sequence 125 to generate an output 150. For example, the system 100 can decode only the output 134 and semantic 132 tokens to generate the output elements 154. As another example, the system 100 can decode the alignment tokens 130, the semantic tokens 132, and the output tokens 134, e.g., to provide the alignment information encoded by the alignment tokens 130.

In particular, the system 100 can use a decoder 140 to decode the semantic 132 and output 134 tokens and can apply the relevant alignment mapping encoding function(s) 165 to decode the alignment 130 tokens to generate the output 150.

The decoder 140 can be a decoder neural network with any appropriate machine learning architecture that can be configured to process the semantic 132 and output 134 tokens to generate the corresponding output elements 154. For example, the decoder 140 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In particular, the system 100 can be used to generate media, e.g., text, image, audio, video data, etc., as the output 150. In the case that the system 100 generates multiple types of media tokens using the sequence generation neural network 120, the system 100 can use one or more respective decoder models for each output modality in the output elements 154.

As an example, a text decoder model can be implemented as a long-short term memory (LSTM) decoder, gated recurrent unit (GRU) decoder, attention-based decoder, etc. As another example, an image decoder model can be implemented as a convolutional neural network (CNN), generative adversarial network (GAN), variational decoder, etc. As yet another example, a video decoder model can be implemented as a convolutional LSTM, GAN, convolutional decoder, etc. As a further example, an audio decoder model can be implemented as a CNN, RNN, variational decoder, etc.

The system 100 can use the alignment mapping encoding function(s) 165 to decode the alignment tokens 130. In this context, decoding the alignment tokens 130 refers to evaluating the alignment tokens 130 with respect to the alignment mapping encoding function(s) 165 to recover the encoded alignment information, e.g., the relationship between the input 105 and the output elements 154 in the output 150 as specified by the alignment mapping encoding function(s) 165. In particular, the system 100 can use the definition of the one or more alignment mapping encoding function(s) 165 that govern the generation of the alignment tokens 130 to determine the alignment 152.

More specifically, the system 100 can generate and provide the alignment 152, e.g., to a user, at inference time by decoding the alignment tokens 130. Furthermore, as opposed to requiring the use of other post-processing models to generate the explicit alignment 152 from the output 150, the system 100 can directly use the alignment 152 information encoded by the alignment tokens 130 for one or more downstream tasks.

For example, in the case of a text-to-speech task, the system 100 can provide the alignment 152 without additionally processing the input 105 and the generated output 125 from the sequence generation neural network 120 using a forced alignment model, e.g., a Hidden Markov Model (HMM), to generate the explicit alignment 152, e.g., for highlighting the text on a display as the generated output audio is played on a user device. As another example, in the case of an image generation task from a prompt specifying the contents of the image to be generated, the system 100 can provide the bounding boxes around objects, actions, etc. without the need to use an object detection neural network, e.g., thereby enhancing the semantic accountability and openness of the model output based on the input to a user.

In the particular example depicted, the system 100 can train the sequence generation neural network 120 using an alignment training subsystem 160. More specifically, the system 100 can train the sequence generation neural network 120 to generate the combined output sequence of tokens 125 using an objective function that measures a discrepancy between the combined output sequence of tokens 125 and a ground truth combined output sequence of tokens comprising one or more ground truth alignment tokens 180. In particular, the subsystem 160 can obtain ground truth alignment tokens 180, e.g., alignment tokens that have been generated according to one or more defined alignment mapping function(s) 165.

As an example, the subsystem 160 can receive an indication of one or more alignment mapping function(s) 165 to use for training the sequence generation neural network 120. As another example, the subsystem 160 can provide one or more particular alignment mapping function(s) 165 as a default. Example sparse and dense alignment mapping encoding functions will be described in more detail with respect to FIG. 2.

In some cases, the subsystem 160 can receive the ground truth alignment tokens 180, e.g., as an input to the system 100. In this case, the ground truth alignment tokens 180 can have been generated using one or more alignment mapping function(s), e.g., external to the system.

In other cases, the subsystem 160 can generate the ground truth alignment tokens 180. In the particular example depicted, the alignment training subsystem 160 can receive a training input sequence of tokens 112, e.g., from tokenizing a model input 105 that is included in a dataset of training examples, as described above. In particular, the training examples can include a set of training model inputs and a corresponding set of ground truth outputs 170. The subsystem 160 can then encode the ground truth alignment tokens 180 in accordance with the one or more alignment mapping encoding function(s) 165 by processing the training input sequence of tokens 112 and the ground truth output 170.

As an example, the ground truth alignment tokens 180 can be generated as an output of processing a training input sequence of tokens 112 and the ground truth output 170 using a forced alignment model. In particular, the system 100 can employ a forced alignment model to align a text input or output with a corresponding audio output or input, e.g., in a text-to-speech or speech-to-text task, according to the alignment mapping function 165. As an example, the system can use a Hidden Markov Model (HMM) to model a sequence of speech sounds as a sequence of states corresponding to phoneme subunits from a probability distribution of phoneme subunits. In some cases, the system 100 can use a context-dependent HMM, Hidden Semi-Markov Model, Deep Neural Network-HMM, etc. as the forced alignment model.

As another example, in the case that the ground truth output 170 includes one or more images, the ground truth alignment tokens 180 can be generated by processing the one or more images using an object detection model to generate bounding boxes, e.g., around areas or objects of interest. The system 100 can then map the generated bounding boxes to the model input to generate the ground truth alignment tokens 130 according to the alignment mapping encoding function(s) 165.

In particular, the subsystem 160 can obtain ground truth alignment tokens 180 for a set of training model inputs and can train the sequence generation neural network 120 to generate the combined output sequence of tokens 125 using an objective function that measures the discrepancy between a ground truth combined output sequence of tokens and the combined output sequence of tokens 125. More specifically, the subsystem 160 can train the sequence generation neural network 120 using an objective function that measure a discrepancy between (i) the ground truth sequence of output tokens pertaining to content and the output sequence of tokens 132 and 134 and (ii) one or more corresponding ground truth alignment tokens 180 and the generated alignment tokens 130, e.g., in accordance with the one or more alignment mapping encoding functions 165. In particular, the alignment training subsystem 160 can calculate a loss 175, e.g., using a cross-entropy loss or a mean squared error loss, using the objective function and the sequence generation neural network 120 can be trained using any appropriate machine learning training technique.

For example, the subsystem 160 can use a stochastic gradient descent training technique, e.g., by calculating and backpropagating gradients of the objective function to update parameter values of the sequence generation neural network 120, e.g., using the update rule of any appropriate gradient descent optimization algorithm, e.g., RMSprop or Adam. In particular, the alignment training subsystem 160 can train the sequence generation neural network 120 at each of a number of training iterations until a training termination criterion is met.

After the training process is complete, the sequence generation neural network 120 can generate alignment tokens 130 at inference time according to the one or more alignment mapping function(s) 165 that were employed to generate the ground truth alignment tokens 180 during training. As mentioned previously, the alignment mapping function 165 can be any arbitrary mapping function. In some cases, the alignment mapping function 165 can be chosen according to the application, e.g., a user can configure the system to generate a combined output sequence 125 for a set of model inputs and ground truth outputs, e.g., a set of text-to-speech model inputs and ground truth outputs, with multiple alignment mapping functions and can select an alignment mapping function 165 based on a measure of performance for the application, e.g., the lowest word error rate.

FIGS. 2A and 2B depict example alignment mapping encodings within the context of generating an audio transcript using a text-to-speech sequence generation neural network. In particular, FIG. 2A presents a sparse alignment mapping encoding 205 in panel 200 and FIG. 2B presents a dense alignment mapping encoding 255 in panel 250.

In both the sparse 205 and the dense 255 alignment encodings depicted, the system generates the same number of alignment tokens as the output, e.g., for a fixed time resolution. In particular, the input sequence of tokens sᵢ, . . . , sⱼ can be considered to be aligned with the output sequence of tokens tₖ, . . . , tₗ the according to a mapping encoding function m(sᵢ, sⱼ)=(tₖ, tₗ). As described in FIG. 1, the text-to-speech sequence generation neural network can be augmented to predict two sequences: the original output sequence and another sequence a₁, . . . , a_{T} representing the alignment. Since the alignment sequence is the same length as the output sequence, the system can train the model to output an interleaved sequence as the final output sequence, e.g., the model can be trained to predict the sequence a₁, t₁, . . . , a_{T}, t_{T}.

In the case of the sparse alignment mapping 205 in panel 200, the system can generate the alignment tokens by marking the start and end of each output element, e.g., word, with a starting and ending token with corresponding values. For example,

aₖ=i if m(sᵢ,·)=(tₖ,·),

aₖ=j if m(·,sᵢ)=(·,tₖ),

aₖ=0 otherwise,

where m is the alignment mapping encoding function.

In particular, for each word, the system can generate a first alignment token with a first value designating a start of the output element and a second alignment token with a second value designating an end of the output element, e.g., the alignment sequence is non-zero only at the alignment boundaries of each output element. More specifically, the system can generate token 210 and token 215 as the start and end of “I”, tokens 220 and 225 to designate the start and end of “repeat”, tokens 230 and 235 to designate the start and end of “time”, tokens 240 and 245 to designate the start and end of “five”, etc. As depicted, the portions of the audio signal that correspond to the individual transcript words “I”, “repeat”, “time”, etc. can be directly associated with the corresponding text input based on the boundaries encoded by the sparse alignment mapping function 205.

In this case, the system can include the trailing spaces of the transcript to generate the alignment, e.g., “I_” where the _ denotes the trailing space. In particular, the system can accommodate different representations in the transcript to separate words, e.g., commas, by including the separation object in each output element.

In the case of the dense alignment mapping encoding 255 in panel 250, the system can generate the alignment tokens by marking the start and end of each output element, e.g., word, with a starting and ending token with the same value. For example, the system can repeat the value of the end token throughout the output element, e.g.,

aₖ=j if m(sᵢ,sⱼ)=(t_{k′},tₗ) for k′≤k≤l

aₖ=0 otherwise,

where m is the mapping encoding function.

In particular, for each word, the system can generate an alignment token with a value that is repeated for every token of the output element, e.g., the alignment sequence is zero only for tokens that are not explicitly aligned, e.g., non-speech events, pauses, etc. More specifically, the system can generate and repeat token 260 for each output token in “I”, token 270 for each output token in “repeat”, token 280 for each output token in “time”, token 290 for each output token in “five”, etc. As depicted, the portions of the audio signal that correspond to the individual transcript words “I”, “repeat”, “time”, etc. can be directly associated with the corresponding text input based on the explicitly aligned tokens encoded by the dense alignment mapping function 255.

In both the sparse alignment mapping encoding 205 and the dense alignment mapping encoding 255 depicted, the generated alignment tokens are different for each word. More specifically, in the case of repeated words, the system can generate different alignment tokens for each word appearing at different positions in the input text. This facilitates the distinguishment of identical repeated words and allows for a more explicit time alignment of the generated output audio to the input transcript, thereby allowing the system to repeat the output word every time it is encountered in the transcript, e.g., rather than leaving out the repeated output element.

While not depicted, other alignment mapping encodings are possible. For example, the system can repeat the last value in the gap between alignment boundaries in the sparse alignment mapping 205. As another example, the system can interpolate the value of the alignment tokens for each output token in the output elements between the alignment boundaries in the sparse alignment mapping 205. As yet another example, the system can repeat a value other than 0 in the dense alignment mapping 255 to denote not explicitly aligned tokens.

In particular, different alignment mapping encodings can be advantageous for different tasks. As an example, in the case that the audio resolution of the token output is not very high, e.g., 25 fps instead of 40 fps, if a following word in the transcript coincides with the end of another and they fall in the same time bucket defined by the audio resolution, then the dense mapping encoding 255 will be better suited for the purposes of distinguishing between the words than the sparse mapping encoding 250. As another example, if speech rate is constant, then interpolating between the end of one word and the beginning of another can be advantageous, e.g., to provide prosody cues.

The system can also be applied to other tasks, e.g., image or video processing. In particular, when there is a direct correspondence between pixels, or image patches, and model output labels, the system can predict bounding boxes around objects of interest in an image, or allow for specific parts of a prompt to be highlighted in the resulting image, etc.

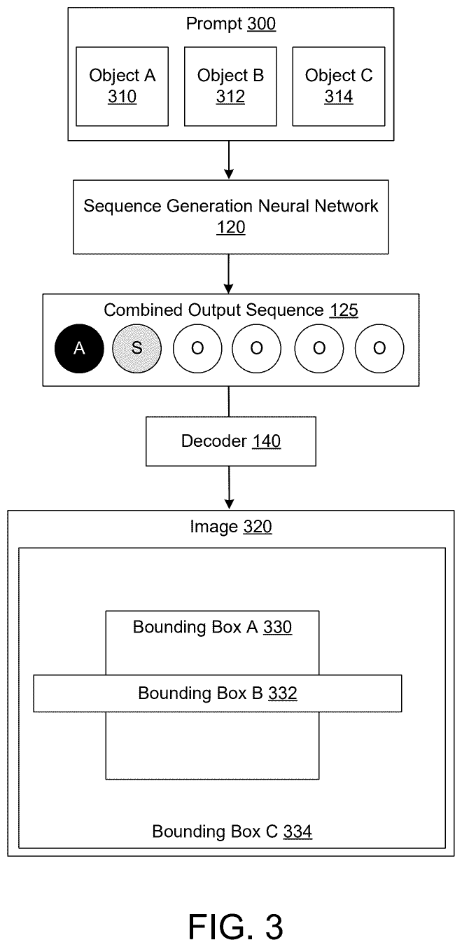

FIG. 3 illustrates an example 300 of processing a textual input to generate an image with bounding boxes provided by the decoding of the alignment tokens in an image processing task.

In particular, the alignment token generation system 100 of FIG. 1 can also be applied to tasks, e.g., image or video processing tasks, where there is a direct correspondence between pixels, or image patches, and model output labels. More precisely, the sequence generation neural network 120 can predict bounding boxes around objects of interest in a generated image 320.

In the particular example depicted, the textual input is a prompt 300, e.g., a directive instruction from a user, to generate an image including one or more objects. In this case, the prompt 300 includes an instruction to generate an image including three objects, e.g., an object A 310, object B 312, object C 314. For example, the prompt 300 can be “generate an image of a Samoyed in a pool innertube in a pool”, e.g., where object A 310 is the Samoyed, object B 320 is the pool innertube, and object B 312 is the pool. In particular, the prompt 300 can include one or more relationships between the objects specified, e.g., that the Samoyed is both in the pool innertube and that the Samoyed and the innertube are in the pool.

The system can then process the prompt as input to the sequence generation neural network 120 to generate a combined output sequence of tokens 125 that can be decoded, e.g., using the decoder 140, to generate the image 320. In this case, the sequence generation neural network 120 can be an image generation network configured to predict sequences of pixels, e.g., an RNN or LSTM, a generative adversarial neural network (GAN), a variational autoencoder (VAE), a transformer, or a CNN, e.g., a PixelCNN, that conditions each generated pixel on previously generated pixels in the output sequence. As another example, the sequence generation neural network 120 can be a diffusion neural network, e.g., a denoising diffusion probabilistic model.

In the particular example depicted, both the output elements and the alignment tokens of the combined output sequence 125 of tokens generated by the sequence generation neural network 120 have been decoded to generate the image 320 of the Samoyed in an innertube in a pool. In this context, the alignment tokens were generated using an alignment mapping encoding function that encodes a mapping between the pixels of the output and bounding boxes around the objects of interest. More specifically, decoding the alignment tokens results in the bounding box A 330, bounding box B 332, and bounding box C 334, which correspond to the respective input elements for object A 310, object B 312, and object C 314.

While not depicted, as another example, the system can be used for visual-question answering (VQA). In this case, the system can process a prompt and one or more images, e.g., from a video, as input. In this case, the image processing task can involve generating an output that requires reasoning, e.g., spatiotemporal reasoning, to respond to a natural language query input, e.g., relating to a moving image (video). For example, the system can process a prompt that includes a query that requires predictive reasoning (“what will happen next”), counterfactual reasoning (“what would happen in a different circumstance”), explanatory reasoning (“why did something happen”), or causal reasoning generally.

In particular, the sequence generation neural network 120 can be used to detect objects in the video frames and provide information relating to the detected objects in response to the prompt, e.g., a request for a prediction of a future event or state relating to one or more of the objects (e.g., “will objects X and Y collide?”), or a request for conditional or counterfactual information relating to one or more of the objects (e.g., “what event would [not] happen if object X is modified, moved or absent?”), or a request for analysis of the video frames to determine a property or characteristic of one or more of the objects (e.g., “how many objects of type Z are moving?”).

In this case, the alignment tokens can indicate which aspects of the one or more video frames were used to determine the response to the query. As an example, the output can include only the response, e.g., from decoding the output tokens only, or the output can include the response to the answer and the bounding boxes, e.g., from additionally decoding the alignment tokens.

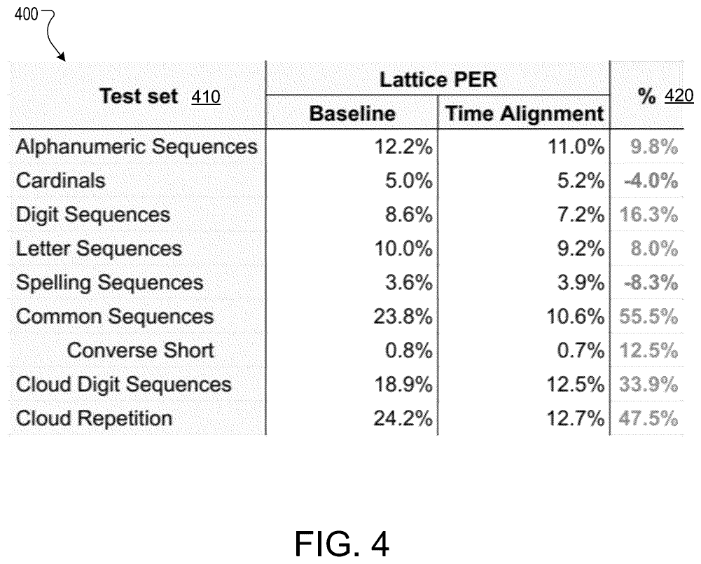

FIG. 4 demonstrates example results of audio generated from a transcript using the example alignment token generation system of FIG. 1. In this case, the alignment tokens are time alignment tokens.

In particular, table 400 illustrates how the system performs in an example text-to-speech task in terms of lattice phoneme error rate (PER) with respect to a baseline approach, e.g., without the incorporated explicit time alignment. In this context, the lattice phoneme error rate refers to the percentage of incorrectly recognized phonemes compared to a reference transcript, e.g., the incorrectly generated phonemes compared to the ground truth transcript.

More specifically, the table 400 includes the provided lattice PER for the baseline approach, the time alignment approach, and a percentage improvement comparing the time alignment approach with respect to the baseline approach across a number of different test datasets 410, e.g., the alphanumeric sequences (e.g., “I have three thousand three hundred thirty three j as the code”), cardinal numbers (e.g., “that is o seven four four o nine nine eight four”), digit sequences (e.g., “o eight eight eight eight is the code i have”), letter sequences (e.g., “i have x m m m m as the code”), etc. datasets. In this case, the test sets 410 include transcripts of varying difficulties, e.g., based on the contents that are included in the transcript. For example, the cardinal number sequence, spelling sequence, and short conversation datasets (e.g., “If I could witness any historical event I think I would choose . . . ”) are easier to synthesize, e.g., generate the corresponding audio output for, than the common sequences (e.g., “three point one four one five thats four digits of pi”) and cloud digit sequences (e.g., “insurance insurance insurance insurance insurance insurance”) datasets.

As the table depicts in the percent improvement column 420, the time alignment system achieves improvements of up to 55% in PER, with the highest demonstrated improvement for the common sequences (55.5%), cloud repetition (47.5%), and cloud digit sequences (33.9%). In particular, there is a clear demonstrated advantage for the time alignment system, e.g., a 19% improvement as a simple average across the test sets 410 depicted in table 400. There is only a small degradation on two datasets, e.g., the cardinal numbers and spelling sequences datasets, but the absolute change in both cases is small.

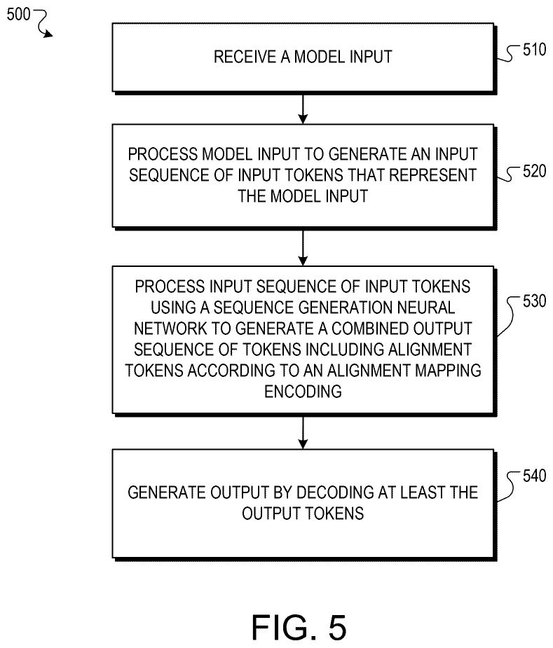

FIG. 5 is a flow chart of an example process for generating an output using a sequence generation neural network that explicitly accounts for the alignment between the input and output. For convenience, the process 500 will be described as being performed by a system of one or more computers located in one or more locations. For example, an alignment token generation system, e.g., the alignment token generation system 100 of FIG. 1, appropriately programmed in accordance with this specification, can perform the process 500.

The system can receive a model input (step 510). As an example, the model input can include one or more of text, image, audio, or video inputs. In some cases, the system can receive a multimodal input including multiple modalities, e.g., a text and an image or video input. In particular, the type of model input can depend on the type of task, e.g., text in a text-to-speech task, audio in a speech-to-text task, an image or video in an object detection task, etc.

The system can process the model input to generate an input sequence of tokens that represents the model input (step 520). For example, the system can process the model input with a tokenizer to generate the corresponding input sequence of tokens, e.g., to identify one or more subunits of the model input as tokens. In some cases, the system can use a rules-based tokenizer and embed the corresponding tokens, e.g., using an embedding model. In other cases, the system can directly embed the model input as a sequence of token embeddings.

The system can process the input sequence of tokens using a sequence generation neural network to generate a combined output sequence of tokens including alignment tokens according to an alignment mapping encoding (step 530). More specifically, each alignment token in the combined output sequence of tokens can specify an alignment between at least one of the input tokens and one or more of the output tokens, e.g., the mapping can be one-to-one, many-to-one, or one-to-many, for the input tokens and one of the output tokens according to an alignment mapping encoding.

For example, the sequence generation neural network can be an autoregressive neural network that can autoregressively generate the combined output sequence of tokens. In particular, the combined output sequence of tokens can include alignment tokens and output tokens, e.g., the alignment and output tokens can be interleaved. In this case, the output sequence of tokens can include an alternating sequence of an alignment token and a subsequent sequence of one or more output tokens.

In some cases, the combined output sequence of tokens can include at least two sets of alignment tokens, e.g., each with its own respective alignment mapping encoding. The alignment mapping encoding can be any arbitrary function. For example, the alignment mapping encoding can specify generating alignment tokens for each output element encoded by the output tokens, e.g., words, objects, etc.

In some cases, the alignment mapping encoding can specify generating a first alignment token with a first value designating the start of the output element as represented in the output sequence of tokens corresponding to at least one of the input tokens, and a second alignment token with a second value designating the end of the output element corresponding to at least one of the input tokens. In this case, the system can generate alignment tokens with interpolated values between the end of the output element that corresponds with the second alignment token and the start of a next output element with the first alignment token.

In other cases, the system can repeat a token with a particular value from the start of the output element until the end of the output element as represented in the output sequence of tokens, e.g., the value can be the second value indicating the end of the output element. In this case, the system can generate a third alignment token with a third value designating an absence of alignment between the end of the output element and the start of a next output element.

As an example, the system can train the sequence generation neural network to generate the combined output sequence of tokens. In particular, the system can train the sequence generation neural network using an objective function that measures a discrepancy between one or more corresponding ground truth alignment tokens and the generated alignment tokens. In some cases, the system can receive the ground truth alignment tokens.

In other cases, the system can generate the ground truth alignment tokens, e.g., by obtaining a ground truth output for a model input and processing the model input and the ground truth output to generate the ground truth alignment tokens according to the alignment mapping encoding. For example, the system can use a forced alignment model to process the model input and the ground truth output to generate the ground truth alignment tokens. As another example, the system can use an object detection model to generate bounding boxes in a ground truth output image and can generate the alignment tokens by mapping the generated bounding boxes to the model input according to the alignment mapping encoding.

The system can generate the output by decoding at least the output tokens (step 540). In particular, the system can decode one or more of the output tokens and the corresponding alignment tokens. In some cases, the system can decode only the output tokens. In this case, the alignment tokens are used to enhance the quality of the output, e.g., by providing explicit alignment information to the sequence generation neural network to guide the output generation. In other cases, the system can decode both the output tokens and the alignment tokens. In this case, the system can use the explicit alignment information, e.g., for text-to-speech highlighting, to generate bounding boxes, etc.

For example, the model input can include a model transcript, e.g., of a number of semantic segments, e.g., words, phonemes, sub-phonemes, etc., and the system can generate an audio output including a spoken variant of the number of semantic segments. In this case, the system can generate and decode time alignment tokens to provide explicit time alignment information. As an example, the system can use the time alignment information to determine a highlighting of respective semantic segments in the input transcript that corresponds with the audio output including the spoken variant of the semantic segments, e.g., on the display of a user device. As another example, the time alignment information can also be used to predict a time of speaker change between one or more speakers in the input transcript.

As another example, the model input can include a prompt specifying the generation of one or more images including one or more objects of interest, and the output can include one or more generated images including the one or more objects of interest. In this case, the system can decode the alignment tokens to generate bounding boxes around the objects of interest in the one or more generated images, e.g., for enhanced interpretability or semantic consistency of generated images based on the input, captions or answers in a video question-and answering task, etc.

FIG. 6 is a flow chart of an example process for training a sequence generation neural network to generate one or more alignment tokens as part of a combined sequence of output tokens. For convenience, the process 600 will be described as being performed by a system of one or more computers located in one or more locations. For example, an alignment token generation system, e.g., the alignment token generation system 100 of FIG. 1, appropriately programmed in accordance with this specification, can perform the process 600.

In particular, the system can receive a training model input (step 610). For example, the system can receive a set of training model examples, where each training example includes (i) one or more of text, image, audio, or video inputs and (ii) a corresponding ground truth output. More specifically, the type of model input and ground truth output can depend on the type of task, e.g., a text input and a speech ground truth output in a text-to-speech task, an audio input and a text ground truth output in a speech-to-text task, an image or video input and a ground truth bounding box output in an object detection task, etc.

The system can process the training model input to generate a training input sequence of input tokens that represent the training model input (step 620). For example, the system can process the training model input with a tokenizer to generate the corresponding input sequence of tokens, e.g., to identify one or more subunits of the model input as tokens. In some cases, the system can use a rules-based tokenizer and embed the corresponding tokens, e.g., using an embedding model. In other cases, the system can directly encode the model input as a sequence of token embeddings.

The system can process the training input sequence of input tokens using a sequence generation neural network to generate a combined output sequence of tokens including alignment tokens according to the alignment mapping encoding (step 630). As described with respect to FIG. 5, the sequence generation neural network can be an autoregressive neural network that can autoregressively generate the combined output sequence of tokens. In particular, the combined output sequence of tokens can include alignment tokens and output tokens, e.g., the alignment and output tokens can be interleaved.

The system can process the training input sequence and the ground truth output according to an alignment mapping encoding to generate a ground truth combined output sequence including ground truth alignment tokens (step 640). In particular, the system can obtain ground truth alignment tokens, e.g., alignment tokens that have been generated according to one or more defined alignment mapping function(s). In some cases, the system can receive the ground truth alignment tokens as input to the system. In some cases, the system can generate the ground truth alignment tokens by processing the training input sequence of tokens and the ground truth output, e.g., using a forced alignment model.

More specifically, the system can receive an indication of one or more alignment mapping function(s) to use. As an example, the system can receive one or more of a sparse or dense alignment mapping encoding functions, e.g., as described with respect to FIG. 2. In particular, the system can receive the training input sequence of tokens and the corresponding ground truth output. The system can then encode the ground truth alignment tokens in accordance with the one or more alignment mapping encoding function(s) by processing the model input and the ground truth output, e.g., using a forced alignment model.

In particular, the system can employ a forced alignment model to align a text input or output with a corresponding audio output or input, e.g., in a text-to-speech or speech-to-text task, according to the alignment mapping function. As an example, the system can use a Hidden Markov Model (HMM) to model a sequence of speech sounds as a sequence of states corresponding to phoneme subunits from a probability distribution of phoneme subunits. In some cases, the system 100 can use a context-dependent HMM, Hidden Semi-Markov Model, Deep Neural Network-HMM, etc. as the forced alignment model.

As another example, in the case that the ground truth output includes one or more images in an image processing task, the ground truth alignment tokens can be generated by processing the one or more images using an object detection model to generate bounding boxes, e.g., around areas or objects of interest. The system can then map the generated bounding boxes to the model input to generate the ground truth alignment tokens according to the alignment mapping encoding function.

The system can then train the sequence generation neural network using an objective function that measures a discrepancy between the ground truth alignment tokens and the alignment tokens (step 650). More specifically, the system can train using an objective function that measure a discrepancy between (i) the ground truth sequence of output tokens pertaining to content and the output sequence of tokens pertaining to content and (ii) one or more corresponding ground truth alignment tokens and the generated alignment tokens, e.g., in accordance with the one or more alignment mapping encoding functions. In particular, the system can calculate a loss, e.g., using a cross-entropy loss or a mean squared error loss, using the objective function and the sequence generation neural network can be trained using any appropriate machine learning training technique.

For example, the system can train the sequence generation neural network at each of a number of training iterations until a training termination criterion is met. In particular, the system can use a stochastic gradient descent training technique, e.g., by calculating and backpropagating gradients of the objective function to update parameter values of the sequence generation neural network, e.g., using the update rule of any appropriate gradient descent optimization algorithm, e.g., RMSprop or Adam. After the training process is complete, the sequence generation neural network can generate alignment tokens at inference time according to the one or more alignment mapping function(s) used to encode the alignment tokens of the ground truth combined sequence of output tokens, e.g., as described in process 500 of FIG. 5.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a model input;
processing the model input to generate an input sequence of input tokens that represent the model input;
generating, by processing the input sequence of input tokens using a sequence generation neural network, a combined output sequence of tokens comprising alignment tokens and output tokens, wherein each alignment token encodes an alignment between at least one of the input tokens and one or more of the output tokens according to an alignment mapping encoding; and
generating an output comprising one or more output elements by decoding at least the output tokens.

2. The method of claim 1, further comprising:
training the sequence generation neural network to generate the combined output sequence of tokens using an objective function that measures a discrepancy between the combined output sequence of tokens and a ground truth combined output sequence of tokens comprising one or more ground truth alignment tokens, wherein the one or more ground truth alignment tokens indicate a ground truth alignment between at least one of the input tokens and one or more of the output tokens according to the alignment mapping encoding.

3. The method of claim 2, further comprising determining the ground truth alignment tokens comprising:
obtaining a ground truth output for the model input; and
processing the model input and the ground truth output to generate the ground truth alignment tokens according to the alignment mapping encoding.

4. The method of claim 3, wherein processing the model input and the ground truth output to generate the ground truth alignment tokens comprises processing the model input and the ground truth output using a forced alignment model.

5. The method of claim 3, wherein the ground truth output comprises one or more images, and wherein processing the model input and the ground truth output to generate the ground truth alignment tokens comprises:
processing the one or more images using an object detection model to generate bounding boxes; and
generating the alignment tokens by mapping the generated bounding boxes to the model input according to the alignment mapping encoding.

6. The method of claim 1, wherein each alignment token specifies an alignment between one of the input tokens and one of the output tokens.

7. The method of claim 1, wherein generating the alignment tokens according to the alignment mapping encoding comprises, for each output element encoded by the output tokens:
generating a first alignment token with a first value designating a start of the output element as represented in the output sequence of tokens corresponding to the at least one of the input tokens; and
generating a second alignment token with a second value designating an end of the output element as represented in the output sequence of tokens corresponding to the at least one of the input tokens.

8. The method of claim 7, further comprising:
generating alignment tokens with interpolated values between the end of an output element that corresponds with the second alignment token with the second value and a start of a next output element with the first alignment token with the first value as represented in the output sequence of tokens.

9. The method of claim 7, further comprising:
repeating the second alignment token with the second value from the start of the output element until the end of the output element as represented in the output sequence of tokens.

10. The method of claim 9, further comprising:
generating a third alignment token with a third value designating an absence of alignment between the end of an output element and a start of a next output element as represented in the output sequence of tokens.

11. The method of claim 1, wherein the combined output sequence of tokens comprises alignment tokens interleaved between the output tokens.

12. The method of claim 11, wherein the alignment tokens interleaved between the output tokens further comprises an alternating sequence of an alignment token encoding an alignment between at least one of the input tokens and a subsequent sequence of one or more output tokens.

13. The method of claim 1, wherein the sequence generation neural network is an autoregressive neural network, and wherein generating the combined output sequence of tokens further comprises autoregressively generating the combined output sequence of tokens.

14. The method of claim 13, wherein the model input comprises an input transcript comprising a plurality of semantic segments, and wherein the output comprises an audio output comprising a spoken variant of the plurality of semantic segments.

15. The method of claim 14, wherein the alignment tokens are time alignment tokens, and wherein generating the combined output sequence of tokens comprises:
generating, for each time frame in the audio output, an interleaved sequence of time alignment tokens and output tokens.

16. The method of claim 15, further comprising:
predicting a time of speaker change between one or more speakers in the input transcript using the time alignment tokens.

17. The method of claim 15, further comprising:
determining a highlighting of respective semantic segments in the input transcript that corresponds with the audio output comprising the spoken variant of the plurality of semantic segments using the time alignment tokens.

18. The method of claim 1, wherein the model input comprises a prompt specifying the generation of one or more images comprising one or more objects of interest, and wherein the output comprises one or more generated images comprising the one or more objects of interest.

19. The method of claim 18, further comprising:
generating bounding boxes around the objects of interest in the one or more generated images using the alignment tokens.

20. The method of claim 18, wherein the sequence generation neural network is a diffusion neural network.

21. The method of claim 1, wherein the combined output sequence of tokens comprises at least two sets of alignment tokens, wherein each set of alignment tokens encodes a respective alignment mapping encoding.
